(19) United States
(12) Patent Application Publication
(10) Pub. No.: US 2018/0113841 A1
(43) Pub. Date: Apr. 26, 2018

(54) DATA TAGGING AND LINKING FOR IMPROVED COMPUTING

(71) Applicant: Blyncsy, Inc., Salt Lake City, UT (US)

(72) Inventors: Mark Pittman, Salt Lake City, UT (US); Patrick Brown, Salt Lake City, UT (US); David Lewis, Salt Lake City, UT (US)

(21) Appl. No.: 15/793,637

(22) Filed: Oct. 25, 2017

Related U.S. Application Data
(60) Provisional application No. 62/412,394, filed on Oct. 25, 2016.

(51) Int. Cl. G06F 17/11; G06F 17/30; G06F 7/48

(52) U.S. Cl. CPC G06F 17/11; G06F 7/48; G06F 17/30946; G06F 17/30979

(57) ABSTRACT

A method of improving computing efficiency of a computer may include receiving instructions for performing an overall calculation comprised of a plurality of sub-calculations. Whether a sub-calculation has been previously performed may be determined and the sub-calculation may be identified as a prior sub-calculation. Whether the prior sub-calculation was calculated with a time-dependent data set having original data may be determined. Whether the time-dependent data set has changed data since the prior sub-calculation may be determined. The sub-calculation may be performed to include a new sub-calculation with the changed data to obtain changed sub-calculation results. The overall calculation may be performed with the changed sub-calculation results. If the time-dependent data set does not have changed data, an original sub-calculation result based on the time-dependent data set having the original data may be identified and utilized in the overall calculation instead of performing the new sub-calculation.

### CROSS-REFERENCE TO RELATED APPLICATIONS

This application claims the benefit of U.S. Patent Application No. 62/412,394, filed Oct. 25, 2016, titled DATA TAGGING AND LINKING FOR IMPROVED COMPUTING, which is incorporated herein by reference in their entireties.

### BACKGROUND

Generally, the present technology relates to computing techniques and computing modules configured for implementing the computing techniques in order to improve computing power and speed.

The claimed subject matter is not limited to embodiments that solve any disadvantages or that operate only in environments such as those described above. This background is only provided to illustrate examples of where the present disclosure may be utilized.

### BRIEF DESCRIPTION OF THE DRAWINGS

FIG. 1 illustrates an example of a computing system.

FIG. 2 illustrates another example of a computing system.

FIG. 3 illustrates an example of a computing device.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Generally, the present technology relates to computing techniques and computing modules configured for implementing the computing techniques in order to improve computing power and speed. The computing techniques identify raw data and/or computed data that has been used for performing specific calculations and determines whether or not specific raw data and/or specific computed data is the same or different from a previous calculation of the specific calculation. The computing technique then configures a calculation protocol based on whether or not the specific raw data and/or specific computed data is the same or different from a previous calculation of the specific calculation. When the specific raw data and/or specific computed data is the same from a previous calculation of the specific calculation, the computing technique then configures the calculation protocol to use the specific computing outcome or specific computing result in the current specific calculation. When the specific raw data and/or specific computed data is different from a previous calculation of the specific calculation, the computing technique then configures the calculation protocol to not use the prior specific computing outcome or specific computing result in the current specific calculation, instead the new specific raw data and/or specific computed data is used in the current specific calculation.

In one embodiment, the computing techniques can be used in data analytics. However, the computing techniques can be used in any computing process that derives data from other pieces of data, where the data used in the computing process may be the same as prior data or the data may change from the prior data and thereby be new data. The computing technique allows the computing protocol to be performed faster when the current data has not changed from the prior data because a prior result can be accessed and then used in the current calculation instead of recalculating with the same data (e.g., current data is same as prior data) that has not changed. The computing technique allows for complicated calculations that used massive amounts of data or data sets to be parsed into new calculations based on new data that has changed since the prior calculation and accessing prior calculation results (e.g., based on prior data being the same as current data) instead of repeating identical calculations with identical data, where the accessed prior calculation results can be used in the complicated calculations with new calculation results in order to obtain the overall result(s).

In some instances, a complicated calculation will be based on old calculation results and new calculation results, such as in a combination where some old calculation results are still valid when the old data and current data are the same in a first part, and where some old calculation results are not valid and new calculations are required with the new data in a second part, where the old calculation results are accessed and computed with new calculation results to obtain the overall calculation result. The first part and second part can both be used in the complicated calculation, where use of the first part saves time in the complicated calculation.

In some instances, a prior calculation result can be obtained from a prior calculation database or repository. Here, the computing protocol can query whether the current calculation (e.g., current data) is based on prior data (e.g., same as current data) and/or new data (e.g., current data different from prior data), and when based at least partly on prior data (e.g., prior data same as current data), the results from that prior data can be accessed and utilized in the current computing protocol.

Accordingly, the present computing systems can include a computing module that performs the analysis on the data, determines whether data has changed, and then determines a computing protocol depending on whether or not the data changed (e.g., current data same or different from prior data).

In one embodiment, computing systems and computing protocol that perform data analytics by running the same calculations repeatedly (e.g., continuously, intermittently, or on demand) can now include the computing module for determining the computing protocol. When computing systems and computing protocols perform the same calculations repeatedly there is an opportunity for the data used in the repeated calculations to remain the same and not change (e.g., current data same as prior data), and as a result, the computing outcomes remain the same. Instead of duplicating the calculation, the prior computed result can be utilized instead of re-performing the same calculation when the current data is the same as the prior data. This includes raw data as well as computed data being the same or different. This is helpful when the computing protocols perform the same analyses and calculations each time they run. Instead of repeating calculations when the current data is the same as the prior data, the results are accessed and used. In largescale complicated calculations, omitting calculation steps can save on computing costs and can result in faster computing for results. In one example, this can be useful in cloud computing where multiple computers are working together to solve complicated calculations, where omitting calculations in favor for using pre-existing calculation results when the current data is the same as the prior data can drastically reduce the computing needs for the current calculation. This computing protocol can reduce computing costs and time, especially for largescale complicated calculations that utilize multiple computers.

In one embodiment, the computing protocol can tag and track dependencies between pieces of information (specific data) while also storing that information (specific data and/or dependencies thereof). Similarly, the computing protocol can tag and track identicalness between pieces of information (specific data, prior specific data compared to current specific data) while also storing that information (specific data, identicalness between prior data and current data). Each piece of information (specific data) is given a globally unique identifier (specific data identifier) and each piece of information (specific data and/or specific data identifier) is then linked to the pieces of information it was derived from (base data). Optionally, the specific data and/or globally unique identifier (specific data identifier) can be linked to derivative information (derivative data) that is derived from the specific data. This allows the base data, specific data, or derived data to be reused when the same or unchanged from prior data to current data in a new calculation. When the specific data is changed, then an assessment is made as to where the data changed to result in the change, and then the new calculation is performed with the changed data (e.g., changed base data or changed specific data). Any discrete data can have a globally unique identifier. For example, when those pieces of information change, the dependent pieces of information that are derived therefrom can be invalidated, the invalidated pieces of information are then not used in the calculation thereby preventing the display of outdated derived information (outdated derived data). When other pieces of information that depend on already calculated pieces of information are calculated, the system knows what calculations have already been completed and can uses the stored values of the computational results rather than recalculating and obtaining those stored values of the computation result again. Once the computational result for discrete data in a computing protocol is known, it can be stored, accessed, and used instead of being recalculated.

The computing protocols described herein shorten the overall calculation time for a given piece of information when some of its dependencies have already been calculated. This allows usage of a dependency when the prior data is the same as the current data used to calculate the dependency. When any piece of information (specific data) is updated or changed the computing protocol can know what other piece/pieces of information (derived data) are affected, and then perform new calculations based on the update or changed pieces of information (new specific data). The calculation results based on the new specific data can be stored for access and use in later calculations, such that current specific data can become prior specific data in a subsequent calculation. After a series of data updates, the database or data repository can have a plurality of sets or libraries of base data, specific data, and derived data that can be selected from for new calculations when the current data is the same as the prior data. This improvement in reduced computing requirements can be beneficial to any computer or computing system that performs data analytics, especially when some data stay constant over multiple calculation cycles. The computing protocol does not change the computation, but does change how it is computed and thereby increases the efficiency of the new calculation.

In one embodiment, the computing protocols can implement dynamic programming where the computing protocol stores the results of a computation in a database or repository. Additionally, now the dynamic programming can be enhanced by the computing protocol making a specific definition of what that computation is. The computing protocol tags/labels the computation and tags/labels the data used in the computation as well as dependencies of the data and calculation results from the data. This allows for the computing protocol to have a more generalized way of describing this computation. This also allows for the computing protocol to store the tagged/labelled computation and/or store the tagged/labelled data used in the computation. This also allows for the computing protocol to represent the tagged/labelled computation and/or tagged/labelled data for acquisition. This also allows for the computing protocol to determine the way that any particular computation depends on other things, such as other data (base data) and other computations. The computing protocol can control the process of calculating those other things (such as other data (base data) and other computations) and bringing it all together in the computation and derivation of a result. When prior data and prior calculations are the same as current data and calculations, instead of recalculating with the current data, the prior data and/or prior calculations are obtained and then utilized in the overall computation.

In one example, software instructs the computing system on where to obtain the predetermined information, such as a previously calculated result, for processing in a new calculation. Also, the software can instruct the computing system on how to handle any informational dependencies (e.g., changes between prior data and new/current data, and any derivative changes of results therefrom). The software can instruct the computing system on when to invalidate those dependencies, and when invalidated, then perform new calculations with new data to obtain newly calculated dependencies. Each iteration of newly calculated dependency can be stored for later use as prior data. For example, the computing system can tag specific data with time series data so the specific data from a certain date or certain time period does not change, and then with the computing protocols can be performed by using the results obtained from the prior data with the new data to get new results.

When any sort of block of data, which can be defined in any arbitrary way, changes, then the computing protocol knows that the results of that change could have possibly changed and all of the subsequently derived or calculated data all the way up the chain to the final result may change. When the current block of data changes compared to a prior block of data, the calculation is performed with the current block of data. For example, an hour of data changes for some reason, which results in the computing protocol acquiring the updated data and determining subsequently derived data that will change based on the updated data, and calculations are performed to obtain the updated subsequently derived data. This functionality can be performed because the computing protocol has access to a record of every piece of data that depends on the updated data. The computing protocol determines that a new calculation is needed with the updated data, and then the computing system performs the calculation to obtain the updated subsequently derived data as a new result. However, when the data has not changed, the prior result obtained with that prior data (e.g., prior data same as current data) can be utilized in the computing protocol to increase overall computing speed.

In one embodiment, a computing system or computing protocol can continually (e.g., continuously, intermittently, or on-demand) perform a lot of similar computations (e.g., including one or more same equations or same algorithms) on the same data (e.g., prior data or current data) for related analytics in order to provide results for a desired analysis. In one example, a user can log into a user interface (e.g., website, open or private) and access data information for a specific time period, and selections for the analysis are entered into the computing system. The computing protocol (e.g., using the computing system) can then perform the appropriate overall calculation by implementing a plurality of sub-calculations. In one scenario, data used in the computations has changed since the last computation, where the current data is different from the prior data. However, the computing system or computing protocol has not tagged the current data as changed compared to the prior data. Had the computing system or computing protocol been updated with information that the current data had changed, the cache of the computing system or computing protocol would have been updated with the data values for this time period (e.g., for a certain location, see incorporated references). However, when the computing system or computing protocol is instructed to perform a new computation with one or more of the same calculations, the computing system or computing protocol can determine if the underlying data has changed or stayed the same. When the same (e.g., prior data same as current data), the computing system or computing protocol utilizes results from the same data in the computation. When different, the computing system or computing protocol performs a new calculation with the different data, which results are then used in the computation. Accordingly, the computing system or computing protocol can have information to “know” when data used in a calculation has changed so that the calculation result has changed, and similarly know when the data and corresponding result are the same. When the underlying data changes, all the data and results derived therefrom (e.g., derived data) is recalculated and tagged. When the underlying data does not change, the prior data (e.g., derived data) that is stored and tagged is used and thereby a new calculation does not need to be performed. Use of prior results without having to re-perform the calculation can increase the speed of the overall computation.

In one embodiment, the system stores dependent data (e.g., derived data) based on data used in calculations to arrive at the dependent data. The dependent data can then be accessed and used in calculations instead of recalculating the dependent data in each overall computation.

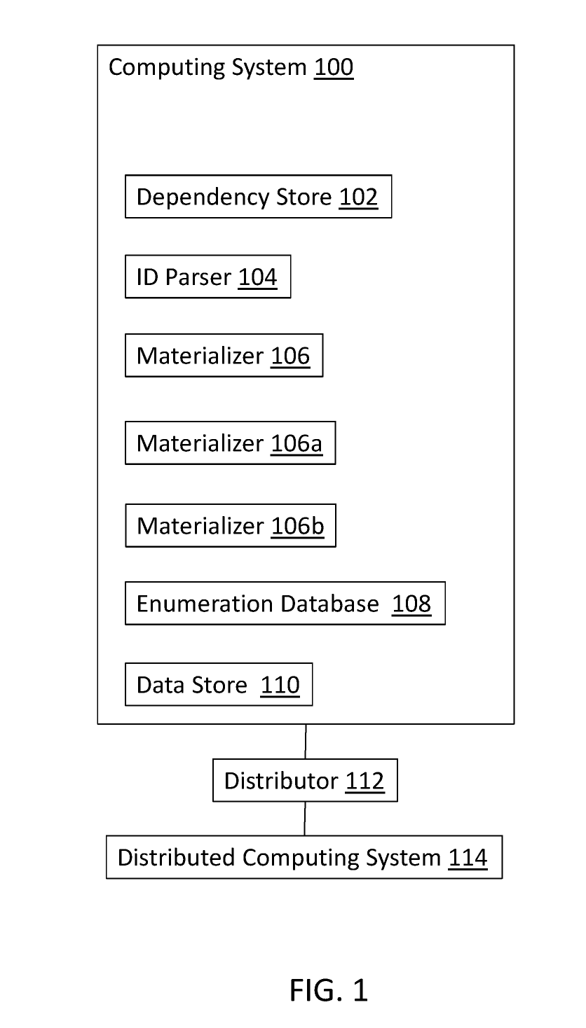

In order to implement the computing protocols described herein, a computing system 100 can be configured with computing modules for performing the functions, which is shown in FIG. 1. The computing system 100 can include a dependency store 102 that is configured to dependencies. The dependencies can be results of calculations (e.g., sub-calculations) based on a specific data. The dependency store 102 can tag the dependencies as well as the base data and calculations used to obtain the dependencies.

The ID parser 104 is a computing module in the computing system 100 that allows for identification of the desired computation. In a simplified example of counting apples, the ID parser 104 would turn a request for the count of a certain type of apples (e.g., green apples) from a specific location (e.g., Florida) into a unique string that uniquely identifies the request. The ID parser 104 is configured to give the computing system a representation of that data object that is unique. As such, the ID parser 104 can function as an identifier to identify the data relevant in a calculation, so that the computing system 100 can determine if the data of the relevant data is the same or different from a prior calculation. This allows the ID parser 104 to function to identify the relevant data sets. Also, the ID parser 104 can identify the computation.

The computing system 100 can include one or more materializers 106, 106a, 106b where three materializers are shown. The materializer 106 is a computing module configured for computing the calculations using data.

The computing system 100 can include a data store 110 that has data, whether raw data or derived data. The computing system 100 can include a data object that represents how to compute data. The data object can include parameters that affect this data. The data store 110 can include raw data, derived data, the parameters that go into calculating the derived data, and other data objects that are required to calculate the derived data. The materializer 106 is configured with computer software code performs the calculations at any level or aspect of an overall calculation.

The computing system can include an Enumeration Database 108 that includes an enumeration of the data types. The enumeration is a complete, listing of all the types of computations that can be performed.

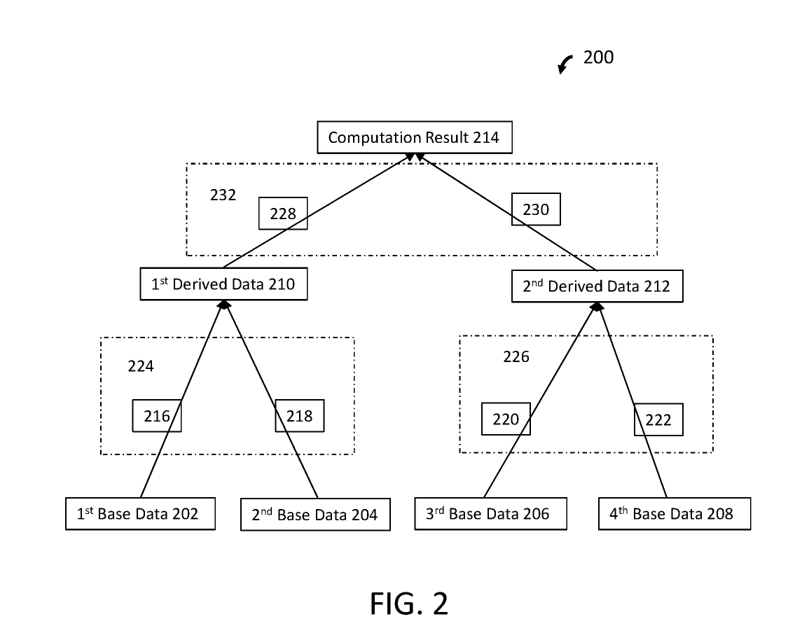

Referring to FIG. 2, a computing system 200 can include multiple sets of base data, such as first base data 202, second base data 204, third base data 206, and fourth base data 208. The base data can be raw data or data used in a computation, such as first primary computation 224 that uses the first base data 202 and second base data 204 or second primary computation 226 that uses the third base data 206 and fourth base data 208. In one example, the base data can be time series data that comes from sensors (see incorporated references). The different base data can be represented by a data object, which can represent certain chunks of the base data. As such, the first base data 202 has a first data object 216, second base data 204 has a second data object 218, third base data 206 has a third data object 220, and fourth base data 208 has a fourth data object 222. The first primary computation 224 arrives at first derived data 210 and second primary computation 226 arrives at second derived data 212. The first derived data 210 can has a first derived data object 228 and the second derived data 212 can have a second derived data object 230. A secondary computation 232 uses the first derived data 210 and second derived data 212 to compute the computation result 214.

In some circumstances, the data sets may be time-dependent data sets. In particular, the some or all of the data sets may include data that changes over time, or data that changes a result of the passing of time. Traffic data is an example of time-dependent data because traffic patterns change throughout the day. For example, traffic volume may be time-dependent because it may change throughout the day. Other types of data may also be time-dependent. In some circumstances, changes to time-dependent data sets may be logged to determine the changes to the data over time, or over a specific time period. Such logs may be used to determine whether a time-dependent data set has changed since a prior calculation or sub-calculation.

Accordingly, the computing system 200 can include data object that represents those chunks of base data. The computing system 200 uses a first materializer for the computation 224 and a second materializer for the computation 226. The materializer is configured to materialize a specific chunk of base data or it materializes based data of a certain type. For each type of base data for given parameters, there can be a materializer that is computed with instructions (e.g., “knows”) on how to turn parameters into whatever the actual data is. There also can be implicit materializer that is a derived data materializer that handles analytics that are based on other forms of data.

The ID parser can give a unique identification for a given data object (e.g., 216, 218, 220, 222). The dependency store can be configured for storing metadata about the information that has already been calculated and metadata of the dependencies (e.g., derived data, or computation results) that rely on any given piece of data (e.g., data in first data base 202). There can also be an enumeration of all the data types. As such, any data can be defined by a data type and relevant data parameters. That data type implicitly includes how to calculate the dependencies of that data based on data parameters, and how to calculate the actual data of the data set. The computing system can enumerate all of the data objects for the computing system to run so the computing system can determine computations.

Referring back to FIG. 1, a distributor 112 may also be included, such as part of the computing system 100 or coupled therewith. The distributor 112 can determine how to spread a complex computation (e.g., overall calculation) across a distributed computing system 114 (e.g., cloud computing system). As such, a computer or multiple computers (E.g., in the same data center) can have a complex computation. The distributor 112 can be a system or computer code for coordinating how these computations might work across a data center, a country, or the whole world where there is multiple different data centers, each that are responsible for some piece of these calculations.

Referring to FIG. 2, when the data in the first base data 202, second base data 204, third base data 206, and fourth base data 208 is the same, and has been used in the calculations to obtain the first derived data 210 and second derived data 212, then the first derived data 210 and second derived data 212 does not need to be recalculated and can be directly used in the calculations to obtain the computation result 214. Once the computation result 214 is calculated, it can be provided or used in another calculation, such as an overall calculation. However, when data of any one of the first base data 202, second base data 204, third base data 206, and fourth base data 208 changes, the data of the first derived data 210 and second derived data 212 may dependently change, and the computation result 214 may dependently change. However, if only one piece of data, such as from the first base data 202, then the first derived data 210 may change and the computation results 214 may change. However, the second derived data 212 does not change when the first base data 202 changes if the third base data 206 and fourth base data 208 change. Then, first primary computation 224 is performed with the updated first base data 202 to get an updated first derived data 210, and then the secondary computation 232 is performed with the updated first derived data 210 and the previously obtained second derived data 212 in order to obtain a new computation result. Using the second derived data 212 instead of recalculating it can speed up the computing process.

In one example, even though the first base data 202 and/or second base data 204 or first primary computation 224 change, the first derived data 210 remains the same, then the computation result is calculated using the first derived data 210 and second derived data 212, without computing these derived data. This can speed up the computation process.

Based on FIG. 2, the computing protocol can minimize or omit recalculations of a computation that arrive at a same result as a prior calculation of the computation.

The computing system can formalize representation of the computation, and the way the system gets the data, where the system gets the data from, the computing system can require the user to specify where the base data is from, where computing system gets the base data from. The materializer can compute the data in different ways depending on user input selections, such as computing for different types of calculation results. Based on the incorporated references, the computing can be for people passing certain sensors at certain times, for people identified to be traveling together, for people identified to be coming from a certain geographical area, and for people going to specific destinations. An example of derived data object can represent the count of people that are passing a certain sensor during rush hour over a week, month, or year.

The dependency store can store connections (e.g., calculations) related to the different data sets so that the computing system can calculate or determine that a certain derived data can rely on two specific pieces of data (e.g., first and second base data). As such, the dependency store can identify a relationship between different pieces of data. If the computing system has calculated a result, there are base values or parameters used in the calculation, and the dependency store identifies where the base values or parameters originated. From the computation result all the way down to the base data, the dependency store identifies links and connections (e.g., calculations) therebetween. This allows the computing system to determine whether or not derived data or a computation result is the same or different in view of the base data.

The materializers can perform the computation steps where the calculations combine data in some way to reach the computation result. The materializer can handle the equations and algorithms in determining the derived data and computation result. The enumeration database can identify the types of computations that can be performed in order to obtain a certain computation result.

In one embodiment, the computation protocol can include a formal representation of information dependencies. The computing system can have a separate parts that receive data (e.g., from sensors), which can determine when the received data has been received and which base data has been updated with the received data. When the system has a change in the base data in the data store, the computing protocol can determine that a chunk of base data is now invalidated.

In one example, the data store can store data that is acquired over a time period or a specific time point. The data stores are a mechanism for the caching of data, whether raw or derived. In some instances, the data store can include intermediate data (e.g., giant chunks of hundreds of terabytes of information) that need to be processed by the system. There can be multiple data stores for different types of data. Each of different type of data can be in a different data store that is operably linked to a different materializer. The computing protocol can determine that a specific data store has changed data, such as, a certain portion of the data store changed or a certain group of data changed, therefore everything that depended on the data store can become invalid, and thereby the computing protocol can recalculate from the base data to the derived data to the final outcome (e.g., computation result) that that is being sought.

Generally, there can be a separation between the invalidation of derivative data, and then the recalculation based on the new data. As such, invalidation can be performed, then there may be a request from a user for data analytics to obtain a certain data paradigm, and after such a request the computing protocol can then perform the required calculations for validating derived data, which is done by recalculation with new data. For example: step one—determine data is invalid; step two—invalidate everything (e.g., derivative data) that depended on the invalidated data; step three—receive a request from a user for ascertaining a certain metric (e.g., computation result) that relies on the invalidated data; step four-perform a recalculation from the new data up to the computation result. During the calculations to obtain the computation result, there can be base data and derived data that has not changed, and thereby the computation also includes using the prior derived data or results in the calculation of the computation result. Omitting recalculations of prior calculations based on results that have not changed can improve the computing speed and require less computing power.

In one embodiment, a computation result may be desired for a massive computation that may take significant time (e.g., hours or days). The computing protocol can determine that some base data has changed, but that the change is insignificant. The computing protocol can estimate the error of using the prior computation result, and provide it to the user, where the user can select to obtain the prior computation result as an estimate.

In one embodiment, the computing protocol described herein can increase computing speed for cloud computing that utilizes a plurality of separate computers for an overall calculation, where sub-calculations are distributed over the plurality of computers.

In one embodiment, the computing protocol described herein can increase computing speed of a personal computer or mobile computer. For example, when the personal computer or mobile computer is performing calculations (e.g., free space calculations or file size calculations or anything) with data on the hard drive, sometimes the data has changed or stayed the same since the last same calculation. The computer can identify the sectors that have the same data and the sectors that the different data. Instead of performing calculations that utilize data that has not changed, those calculations can be omitted and the prior computation result can be utilized. For example, when determining a folder size, the computer takes some time to incrementally count the files and updates. However, with the computing protocols folders without changes are not reassessed, and the prior folder size is used in the calculation.

### Example

A user wants information regarding average speed on a section of road during morning rush hour and evening rush hour. On this road: Morning Rush Hour is from 5 AM to 10 AM; and Evening Rush Hour is from 5 PM to 7 PM. The section of road has sensors at 3 locations (A, B, C), multiple sensors at each (e.g., triangulated positions), arranged as so along the road: A->B->C. The sensors are able to identify cars via some method such as license plate image recognition, or recognize mobile devices located in the car, where the mobile devices historically travel along the section of road during rush hour (e.g., see incorporated references). At noon on a specific day, suppose the user wants to look at the average speed during the morning rush hour on this specific day. The system can take all trips from A->B and B->C and determine the speed of the cars via a simple calculation (for A->B): Distance from location B to location A/(Time car passed location B−Time car passed location A). This value can then be averaged in the usual way to provide some result such as: Average speed during morning rush hour: 35 mph.

If on the same specific day later at 8 PM, the user then wants to compare speeds during morning rush hour and evening rush hour the system can calculate average evening rush hour speed in a similar manner to morning rush hour speed above, and the system can identify that since noon no new data has been received for the hours comprising morning rush hour (as would be typical in time series data cases). As such, the result calculated at Noon can be used for the average speed during morning rush hour. This is because the prior data regarding morning rush hour did not change and is the same as the current data regarding morning rush hour for the same specific day. The results may be: Average speed during morning rush hour: 35 mph; and Average speed during evening rush hour: 40 mph. Then the user may take some action, for example if the user coordinates police officers in their city, and the speed limit on this road is 35 mph, they may place officers on the section of road tomorrow, during evening rush hour, but not morning rush hour. Here, the calculation is simplified by using the prior calculated result of morning rush hour having an average speed of 35 mph instead of recalculating it. While this example is simple, the same approach can be applied to complicated multi-step computations and complex algorithms. For example, the example could be changed to be for hundreds or thousands of specified roadways.

If the user wants to look at the result again at 9 PM for the same specific day, the system can then check if both the sensor data underlying the morning and evening average speed results has changed. If new data was received from a sensor at location A at for 8 AM to 8:30 AM (due to for example a sensor coming back online after reconnecting due to an intermittent cellular data connection) the system would identify the underlying data has changed and recalculate the morning result, but continue to use the previously saved value for the evening result. The new results may be: Average speed during morning rush hour: 36 mph; and Average speed during evening rush hour: 40 mph. In this instance the system would provide the most up to date results based on the data received, while also saving computation time.

In a production system with thousands of users the saved computation time could be very large.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments. Generally, the methods are computing methods performed on a computer or multi-computer cloud computing platform. As such, software can be implemented to perform the calculation protocols described herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only, and is not intended to be limiting.

In one embodiment, the present methods can include aspects performed on a computing system. As such, the computing system can include a memory device (e.g., non-transitory) that has the computer-executable instructions for performing the method. The computer-executable instructions can be part of a computer program product that includes one or more algorithms for performing any of the methods of any of the claims.

In one embodiment, any of the operations, processes, methods, or steps described herein can be implemented as computer-readable instructions stored on a computer-readable medium. The computer-readable instructions can be executed by a processor of a wide range of computing systems from desktop computing systems, portable computing systems, tablet computing systems, hand-held computing systems as well as network elements, and/or any other computing device. The computer readable medium is not transitory. The computer readable medium is a physical medium having the computer-readable instructions stored therein (non-transitorily) so as to be physically readable from the physical medium by the computer.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a physical signal bearing medium include, but are not limited to, the following: a recordable type medium such as a floppy disk, a hard disk drive, a CD, a DVD, a digital tape, a computer memory, any other physical medium that is not transitory or a transmission. Examples of physical media having computer-readable instructions omit transitory or transmission type media such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those generally found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

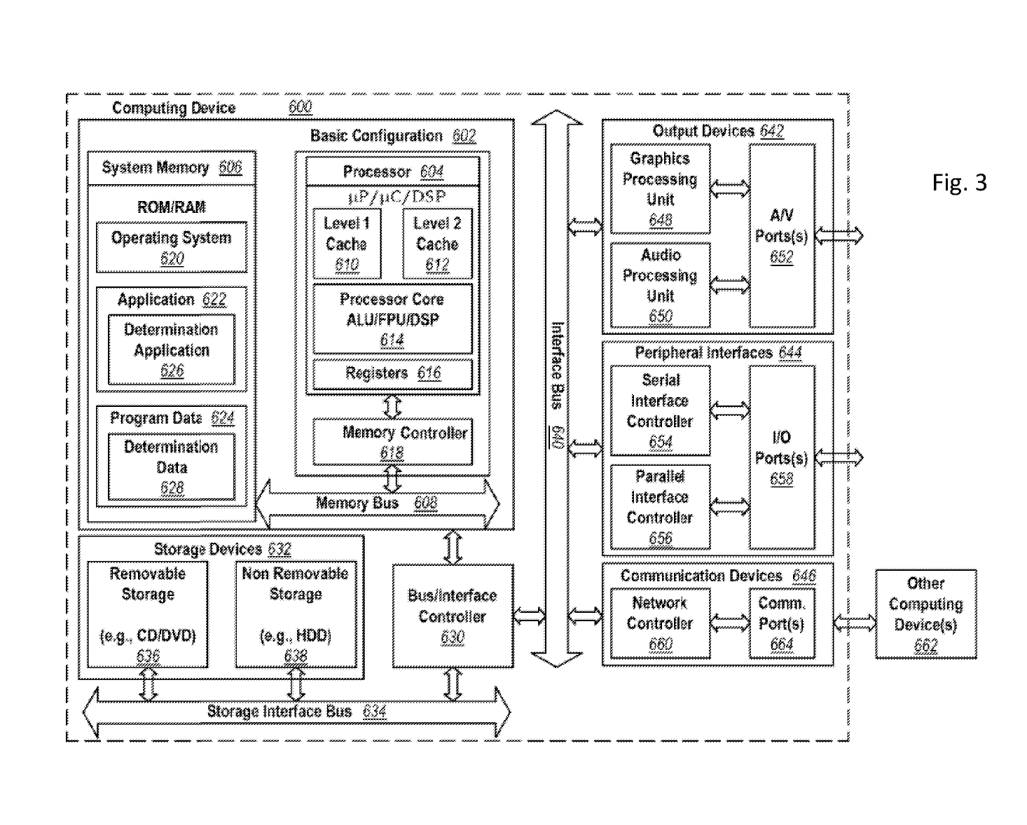

FIG. 3 shows an example computing device 600 that is arranged to perform any of the computing methods described herein. In a very basic configuration 602, computing device 600 generally includes one or more processors 604 and a system memory 606. A memory bus 608 may be used for communicating between processor 604 and system memory 606.

Depending on the desired configuration, processor 604 may be of any type including but not limited to a microprocessor (μP), a microcontroller (μC), a digital signal processor (DSP), or any combination thereof. Processor 604 may include one more levels of caching, such as a level one cache 610 and a level two cache 612, a processor core 614, and registers 616. An example processor core 614 may include an arithmetic logic unit (ALU), a floating point unit (FPU), a digital signal processing core (DSP Core), or any combination thereof. An example memory controller 618 may also be used with processor 604, or in some implementations memory controller 618 may be an internal part of processor 604.

Depending on the desired configuration, system memory 606 may be of any type including but not limited to volatile memory (such as RAM), non-volatile memory (such as ROM, flash memory, etc.) or any combination thereof. System memory 606 may include an operating system 620, one or more applications 622, and program data 624. Application 622 may include a determination application 626 that is arranged to perform the functions as described herein including those described with respect to methods described herein. Program Data 624 may include determination information 628 that may be useful for analyzing the contamination characteristics provided by the sensor unit 240. In some embodiments, application 622 may be arranged to operate with program data 624 on operating system 620 such that the work performed by untrusted computing nodes can be verified as described herein.

Computing device 600 may have additional features or functionality, and additional interfaces to facilitate communications between basic configuration 602 and any required devices and interfaces. For example, a bus/interface controller 630 may be used to facilitate communications between basic configuration 602 and one or more data storage devices 632 via a storage interface bus 634. Data storage devices 632 may be removable storage devices 636, non-removable storage devices 638, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 606, removable storage devices 636 and non-removable storage devices 638 are examples of non-transient computer storage media devices. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 600. Any such computer storage media may be part of computing device 600.

Computing device 600 may also include an interface bus 640 for facilitating communication from various interface devices (e.g., output devices 642, peripheral interfaces 644, and communication devices 646) to basic configuration 602 via bus/interface controller 630. Example output devices 642 include a graphics processing unit 648 and an audio processing unit 650, which may be configured to communicate to various external devices such as a display or speakers via one or more A/V ports 652. Example peripheral interfaces 644 include a serial interface controller 654 or a parallel interface controller 656, which may be configured to communicate with external devices such as input devices (e.g., keyboard, mouse, pen, voice input device, touch input device, etc.) or other peripheral devices (e.g., printer, scanner, etc.) via one or more I/O ports 658. An example communication device 646 includes a network controller 660, which may be arranged to facilitate communications with one or more other computing devices 662 over a network communication link via one or more communication ports 664.

The network communication link may be one example of a communication media. Communication media may generally be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 600 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 600 may also be implemented as a personal computer including both laptop computer and non-laptop computer configurations. The computing device 600 can also be any type of network computing device. The computing device 600 can also be an automated system as described herein.

The embodiments described herein may include the use of a special purpose or general-purpose computer including various computer hardware or software modules.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system. Also, cloud computing systems can implement the computing.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

All references recited herein are incorporated herein by specific reference in their entirety. References: U.S. 62/345,598; U.S. Ser. No. 14/947,388; U.S. Ser. No. 14/947,352; U.S. 62/082,212; U.S. 62/127,638; U.S. 62/197,462; U.S. 62/197,464;

What is claimed is:

1. A method of improving computing efficiency of a computer, the method comprising:
receiving instructions for performing an overall calculation comprised of a plurality of sub-calculations;
determining that a sub-calculation has been previously performed, and identifying the sub-calculation as a prior sub-calculation;
determining that the prior sub-calculation was calculated with a time-dependent data set having original data;
determining that the time-dependent data set has changed data since the prior sub-calculation;
performing the sub-calculation to include a new sub-calculation with the changed data to obtain changed sub-calculation results; and
performing the overall calculation with the changed sub-calculation results,
wherein if the time-dependent data set does not have changed data, an original sub-calculation result based on the time-dependent data set having the original data is identified and utilized in the overall calculation instead of performing the new sub-calculation.

2. The method of claim 1, further comprising:
identifying raw data of the time-dependent data set;
determining when the raw data was obtained; and
determining whether there have been changes to the raw data since the last calculation of derivative data;
if there have been changes to the raw data, calculating derivative data based on changes to the raw data; or
if there the raw data has not changed, obtaining a calculation result based on the raw data.

3. The method of claim 1, further comprising:
identifying computed data of the time-dependent data set; and
determining when the computed data was obtained; and
determining whether there have been changes to the computed data since the last calculation of derivative data;
if there have been changes to the computed data, calculating derivative data based on changes to the computed data; or
if there the computed data has not changed, obtaining a calculation result based on the computed data.

4. The method of claim 1, further comprising identifying raw data and/or computed data that has been used for performing specific calculations and determining whether or not specific raw data and/or specific computed data is the same or different from a previous calculation of the specific calculation.

5. The method of claim 1, further comprising configuring a calculation protocol based on whether or not specific raw data and/or specific computed data is the same or different from a previous calculation of the specific calculation.

6. The method of claim 5, further comprising:
when specific raw data and/or specific computed data is the same from a previous calculation of a specific calculation, configuring the calculation protocol to use the specific computing outcome or specific computing result of the previous calculation of the specific calculation in the current specific calculation; or
when the specific raw data and/or specific computed data is different from a previous calculation of the specific calculation, configuring the calculation protocol to not use the specific computing outcome or specific computing result of the previous calculation of the specific calculation in the current specific calculation, instead the new specific raw data and/or specific computed data is used in the current specific calculation.

7. The method of claim 1, further comprising:
omitting a recalculation of a specific calculation when a specific calculation result of the specific calculation has not changed; and
providing the unchanged specific calculation result to the overall calculation in place of the recalculation.

8. The method of claim 1, further comprising:
parsing the overall calculation into the plurality of sub-calculations having previously been calculated to obtain sub-calculation results;
identifying whether data used in obtaining the sub-calculation results is the same or different from one or more prior sub-calculations; and
when the data used in obtaining the sub-calculation result is the same, including the sub-calculation result in the overall calculation; or
when the data used in obtaining the sub-calculation result is different, performing a new sub-calculation to obtain a new sub-calculation result and including the new sub-calculation result in the overall calculation.

9. The method of claim 1, further comprising:
omitting performing a new sub-calculation that has a same result as a prior sub-calculation; and
computing the overall calculation with the same result of the prior sub-calculation.

10. The method of claim 1, further comprising computing the overall calculation with at least one result of a prior sub-calculation or at least one new result of a new sub-calculation.

11. The method of claim 1, further comprising:
accessing a database of prior sub-calculation results;
extracting one or more prior sub-calculation results; and
computing the overall calculation with the one or more prior sub-calculation results.

12. The method of claim 1, further comprising:
providing a request to a user as to whether or not to consider prior calculation results in the overall calculation; and
receiving an input from the user to provide instructions as to whether or not to use the prior calculation results.

13. The method of claim 1, further comprising:
tagging data of the time-dependent data set;
tagging sub-calculations based on the tagged data; and/or
tagging sub-calculation results based on the tagged sub-calculations and/or tagged data.

14. The method of claim 13, comprising:
comparing the tagged data with current data of the time-dependent data set;
comparing the tagged sub-calculations with new calculations based on the current data of the time-dependent data set; and/or
comparing the tagged sub-calculation results with new sub-calculation results obtained from the new calculations based on the current data of the time-dependent data set.

15. The method of claim 13, wherein the tagging is with a unique identifier.

16. The method of claim 15, further comprising:
indexing the unique identifiers.
accessing the tagged data, tagged sub-calculation, and/or tagged sub-calculation results based on the unique identifier thereof; and
instructing the computing of the overall calculation to determine whether or not a unique identifier is valid based on the tagged data.

17. The method of claim 1, comprising:
determining whether derivative data is based on invalid base data or valid base data;
when based on invalid base data, the derivative data is omitted from computation of the overall calculation;
when based on valid base data, the derivative data is utilized in computation of the overall calculation.

18. A computer program product having a non-transitory memory device with computer executable instructions that when executed by a processor cause a computer to perform the method of claim 1.

19. A method of improving computing efficiency, the method comprising:
receiving instructions for performing an overall calculation comprised of a plurality of sub-calculations;
determining that a sub-calculation has been previously performed, and identifying the sub-calculation as a prior sub-calculation;
determining that the prior sub-calculation was calculated with a time-dependent data set having original data which is valid for a specific time period to obtain an original sub-calculation result;
determining that since the prior sub-calculation, the time-dependent data set still has the original data and is still valid for the specific time period;
obtaining the original sub-calculation result; and
performing the overall calculation with the original sub-calculation result,
wherein if the time-dependent data set has changed data, a changed calculation result based on the time-dependent data set having the changed data is calculated and utilized in the overall calculation instead of with the original sub-calculation results.

20. A computer program product having a non-transitory memory device with computer executable instructions that when executed by a processor cause a computer to perform the method of claim 19.
